(19) United States
(12) Patent Application Publication
(10) Pub. No.: US 2026/0245253 A1
(43) Pub. Date: Aug. 20, 2026

(54) COMPRESSION ULTRAFAST THREE-DIMENSIONAL IMAGING METHOD AND SYSTEM, ELECTRONIC DEVICE, AND STORAGE MEDIUM

(71) Applicant: WUYI UNIVERSITY, Jiangmen (CN)

(72) Inventors: Jiangtao XI, Jiangmen (CN); Zhao MA, Jiangmen (CN); Jiale LONG, Jiangmen (CN); Yingrong LI, Jiangmen (CN); Chuisong MENG, Jiangmen (CN); Kesen HUANG, Jiangmen (CN); Zihao DU, Jiangmen (CN); Jian PAN, Jiangmen (CN); Jiekai ZHUO, Jiangmen (CN); Jianmin ZHANG, Jiangmen (CN); Zaiming LI, Jiangmen (CN); Haoming HUANG, Jiangmen (CN)

(21) Appl. No.: 19/159,482

(22) PCT Filed: Dec. 13, 2023
(86) PCT No.: PCT/CN2023/138500

§ 371 Date: Aug. 25, 2025

(30) Foreign Application Priority Data
Mar. 29, 2023 (CN) 202310326388.3

(51) Int. Cl. G06T 9/00; G06T 5/70

(52) U.S. Cl. CPC G06T 9/001; G06T 5/70

(57) ABSTRACT

A compression ultrafast three-dimensional imaging method includes: encoding a plurality of interference fringe patterns of an object to be detected to obtain an encoded image; compressing the encoded image to obtain a compressed interference fringe pattern of the object to be detected; performing inverse solution processing on the compressed interference fringe pattern to obtain an undecoded interference fringe pattern; performing total variation image denoising on the interference fringe pattern, and then performing deep denoising to obtain a denoised image; and performing three-dimensional imaging on the denoised image to construct a three-dimensional model of the object to be detected.

### CROSS-REFERENCE TO RELATED APPLICATIONS

This application is a national stage filing under 35 U.S.C. § 371 of international application No. PCT/CN2023/138500, filed Dec. 13, 2023, which claims priority to Chinese patent application No. 202310326388.3 filed Mar. 29, 2023. The contents of these applications are incorporated herein by reference in their entirety.

### TECHNICAL FIELD

Embodiments of the present disclosure relate to, but not limited to, the field of three-dimensional imaging, and in particular, to a compression ultrafast three-dimensional imaging method and system, an electronic device, and a storage medium.

### BACKGROUND

Among the existing three-dimensional imaging technologies, the imaging speed of structured light three-dimensional imaging technology can only reach the millisecond level. In addition, image reconstruction algorithms applied to structured light three-dimensional imaging technology, such as TwIST, TVAL3, etc., are not satisfactory in reconstructing interference fringe patterns. Because the interference fringe patterns have dense fringes and curves, the resolution of the reconstructed images is not high.

### SUMMARY

The following is a summary of the subject matter set forth in this description. This summary is not intended to limit the scope of protection of the claims.

An objective of the present disclosure is to solve one of the technical problems in existing technologies at least to a certain extent. Embodiments of the present disclosure provide a compression ultrafast three-dimensional imaging method and system, an electronic device, and a storage medium, to achieve high-precision imaging with ultrafast phase change.

In accordance with a first aspect of the present disclosure, an embodiment provides a compression ultrafast three-dimensional imaging method, including:
encoding a plurality of interference fringe patterns of an object to be detected to obtain an encoded image;
compressing the encoded image to obtain a compressed interference fringe pattern of the object to be detected;
performing inverse solution processing on the compressed interference fringe pattern to obtain an undecoded interference fringe pattern;
performing total variation image denoising on the interference fringe pattern, and then performing deep denoising to obtain a denoised image; and
performing three-dimensional imaging on the denoised image to construct a three-dimensional model of the object to be detected.

In some embodiments of the first aspect of the present disclosure, the inverse solution processing is performed on the compressed interference fringe pattern by solving a to-be-solved equation with an inverse model, to obtain the undecoded interference fringe pattern, where the to-be-solved equation is:

$$\hat{x} = arg {min}_{x} \frac{1}{2} ‖ y - Ax {‖}_{2}^{2} + λ R ( x ) ,$$

where x represents an interference fringe pattern sequence, \hat{x} represents an undecoded interference fringe pattern sequence, y represents a compressed interference fringe pattern, λ represents a noise balance factor, R(x) represents a regularization term, and A represents an operator.

In some embodiments of the first aspect of the present disclosure, the operator is expressed by the following equation: A=TSC, where T represents a spatiotemporal integration operator, S represents a temporal shearing operator, and C represents an encoding operator.

In some embodiments of the first aspect of the present disclosure, the deep denoising is expressed by the following equation:

$${v}^{k + 1} = arg {min}_{v} \frac{{λ}_{1}}{γ} R ( v ) + {‖ {x}^{k + 1} - v ‖}_{2}^{2} ,$$

where x represents an interference fringe pattern sequence, v represents an auxiliary variable, k represents a number of iterations, λ₁ represents a regularization parameter, and γ represents a penalty factor.

In some embodiments of the first aspect of the present disclosure, performing three-dimensional imaging on the denoised image to construct a three-dimensional model of the object to be detected includes:
performing phase reconstruction on the denoised image to obtain a phase map;
unwrapping the phase map to obtain an absolute phase map; and
calculating three-dimensional coordinates of the object to be detected according to the absolute phase map and a preset calibration parameter, to construct the three-dimensional model of the object to be detected.

In some embodiments of the first aspect of the present disclosure, performing phase reconstruction on the denoised image to obtain a phase map includes:
performing a Fourier transform on the denoised image to obtain a first transform map, and performing a Fourier transform on a reference fringe pattern to obtain a second transform map;
filtering the first transform map to obtain a fundamental component of the first transform map, and filtering the second transform map to obtain a fundamental component of the second transform map; and
performing arctangent calculation on the fundamental component of the first transformation map and the fundamental component of the second transformation map to obtain the phase map of the object to be detected.

In some embodiments of the first aspect of the present disclosure, the fundamental component of the first transform map is expressed as: d_{f}(x)=b₁ cos(2πf₀x+ψ₁+Δφ₁(x)); and the fundamental component of the second transform map is expressed as: r_{f}(x)=b₁ cos(2πf₀x+ψ₁), where f₀ represents a spatial frequency of a fundamental component of a fringe; b₁ represents an amplitude of a 1st-order harmonic component of a projected fringe; ψ₁ represents an initial phase of the 1st-order harmonic component; φ₁ represents a phase shift of the 1st-order harmonic component caused by fringe deformation; and

$$Δ {φ}_{1} ( x ) = unwrap ( Im \{ In [ {D}_{f} ( x ) {R}_{f}^{*} ( x ) ] \} ) ,$$

where unwrap represents phase unwrapping, D_{f}(x) represents a complex signal of the fundamental component of the first transform map, R_{f}(x) represents a complex signal of the fundamental component of the second transform map, Im represents taking an imaginary part of a complex number, In represents a natural logarithm, and

$${R}_{f}^{*} ( x )$$

represents a complex conjugate of R_{f}(x).

In accordance with a second aspect of the present disclosure, an embodiment provides a compression ultrafast three-dimensional imaging system, including a light source, a mask, an image capturing device, and an image processing device, where light generated by the light source first passes through the mask and then enters the image capturing device;
the mask plate is loaded with a coding matrix; the mask is configured for encoding a plurality of interference fringe patterns of an object to be detected to obtain an encoded image;
the image capturing device is configured for compressing the encoded image to obtain a compressed interference fringe pattern of the object to be detected;
the image processing device is configured for performing inverse solution processing on the compressed interference fringe pattern to obtain an undecoded interference fringe pattern; performing total variation image denoising on the interference fringe pattern, and then performing deep denoising to obtain a denoised image; and performing three-dimensional imaging on the denoised image to construct a three-dimensional model of the object to be detected.

In accordance with a third aspect of the present disclosure, an embodiment provides an electronic device, including: a memory, a processor, and a computer program stored in the memory and executable by the processor, where the computer program, when executed by the processor, causes the processor to implement the compression ultrafast three-dimensional imaging method.

In accordance with a fourth aspect of the present disclosure, an embodiment provides a computer-readable storage medium, having computer-executable instructions stored therein, where the computer-executable instructions, when executed by a processor, cause the processor to implement the compression ultrafast three-dimensional imaging method.

The above schemes at least have the following beneficial effects. By encoding a plurality of interference fringe patterns of an object to be detected to obtain an encoded image, compressing the encoded image to obtain a compressed interference fringe pattern of the object to be detected, performing inverse solution processing on the compressed interference fringe pattern to obtain an undecoded interference fringe pattern, performing total variation image denoising on the interference fringe pattern and then performing deep denoising to obtain a denoised image, and performing three-dimensional imaging on the denoised image to construct a three-dimensional model of the object to be detected, high-precision imaging with ultrafast phase change can be achieved.

### BRIEF DESCRIPTION OF DRAWINGS

The drawings are provided for a further understanding of the technical schemes of the present disclosure, and constitute a part of the description. The drawings and the embodiments of the present disclosure are used to explain the technical schemes of the present disclosure, but are not intended to limit the technical schemes of the present disclosure.

FIG. 1 is a flowchart of a compression ultrafast three-dimensional imaging method according to an embodiment of the present disclosure;

FIG. 2 is a detailed flowchart of step S500;

FIG. 3 is a detailed flowchart of step S510;

FIG. 4 is a structural diagram of a compression ultrafast three-dimensional imaging system according to an embodiment of the present disclosure; and

FIG. 5 is a structural diagram of an electronic device according to an embodiment of the present disclosure.

### DETAILED DESCRIPTION

To make the objectives, technical schemes, and advantages of the present disclosure clearer, the present disclosure is described in further detail with reference to accompanying drawings and embodiments. It is to be understood that the specific embodiments described herein are merely used for illustrating the present disclosure, and are not intended to limit the present disclosure.

It should be noted that although the functional modules are divided in the schematic diagram of the apparatus and the logical sequence is shown in the flowchart, in some cases, the modules may be divided in a different manner, or the steps shown or described may be executed in an order different from the orders as shown in the flowcharts. The terms such as “first,” “second” and the like in the description, the claims, and the accompanying drawings are used to distinguish similar objects, and are not necessarily used to describe a specific sequence or a precedence order.

The embodiments of the present disclosure will be further described in detail below with reference to the accompanying drawings.

Three-dimensional imaging technology is a technology that uses electronic instruments to acquire three-dimensional spatial information and three-dimensional morphology features of an object to be detected. With the continuous progress of modern electronic technologies and industrial production, people have increasingly strong demand for three-dimensional imaging technologies of objects. Three-dimensional imaging technologies can restore lost depth information and three-dimensional structure of an object to be detected from two-dimensional images of the object. At present, three-dimensional imaging technologies have been widely used in biomedical imaging, industrial production inspection, micro and nano manufacturing, and other fields, and have become an indispensable supporting technology for intelligent manufacturing.

An embodiment of the present disclosure provides a compression ultrafast three-dimensional imaging system. Referring to FIG. 4, the compression ultrafast three-dimensional imaging system includes a light source 101, a mask, an image capturing device, and an image processing device.

The light source includes a femtosecond laser emitter, an attenuator, and a plurality of reflecting mirrors. The femtosecond laser emitter can generate a laser beam with a power of 1300 mw and a wavelength of 800 nm. The attenuator is equipped with a 0.05% output port. In this embodiment, the laser beam is reflected by two reflecting mirrors. Definitely, in some other embodiments, the laser beam may also be reflected by another number of reflecting mirrors according to actual requirements to adjust the light path.

The laser beam generated by the femtosecond laser emitter enters a dark chamber. In the dark chamber, the light path passes through a beam expander 102 and a collimator 103 and is then divided into two light paths by a first beam splitter 104. One of the light paths passes through an optical system of a Mach-Zehnder interferometer to generate interference fringes and then propagates to a second beam splitter 105. The other light path directly propagates to the second beam splitter.

The generated static interference fringes are photographed by a charge coupled device (CCD) camera 106.

The interference fringes are projected onto an object to be detected which is placed on an object placement area 107, and then pass through a camera lens 108 and a third beam splitter 109 in sequence. One light path generated through splitting by the third beam splitter 109 is photographed by a streak camera 110, and another light path generated through splitting by the third beam splitter 109 passes through a tube lens 111 and an objective lens 112 and is encoded by a digital micromirror device 113.

The image capturing device includes the streak camera 110, the CCD camera 106, and the digital micromirror device 113.

Two beams of light are superimposed on a photosensitive element such as the CCD camera 106 to generate interference, and the amount of light sensed by each point on the photosensitive element varies not only with the intensity but also with the phase relationship of the two beams of light. The laser beam passes through the optical system of the Mach-Zehnder interferometer to generate interference fringes, which are projected onto the object to be detected. The diffuse reflected light passes through two 4f systems and the digital micromirror device 113 for image encoding of the interference fringes and enters the streak camera in the compression ultrafast system to realize recording of two-dimensional spatial information of the interference fringes.

The image processing device is configured for performing inverse solution processing on the compressed interference fringe pattern to obtain an undecoded interference fringe pattern; performing total variation image denoising on the interference fringe pattern, and then performing deep denoising to obtain a denoised image; and performing three-dimensional imaging on the denoised image to construct a three-dimensional model of the object to be detected.

In other words, the compression ultrafast three-dimensional imaging system adopts a compression ultrafast three-dimensional imaging method as follows.

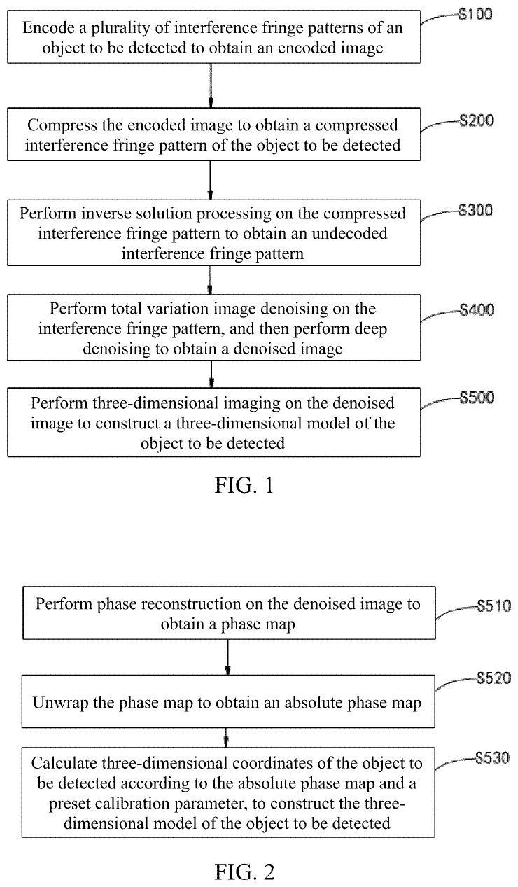

Referring to FIG. 1, the compression ultrafast three-dimensional imaging method includes, but not limited to, the following steps S100 to S500.

At S100, a plurality of interference fringe patterns of an object to be detected are encoded to obtain an encoded image.

At S200, the encoded image is compressed to obtain a compressed interference fringe pattern of the object to be detected.

At S300, inverse solution processing is performed on the compressed interference fringe pattern to obtain an undecoded interference fringe pattern.

At S400, total variation image denoising is performed on the interference fringe pattern, and then deep denoising is performed to obtain a denoised image.

At S500, three-dimensional imaging is performed on the denoised image to construct a three-dimensional model of the object to be detected.

For S100, a laser beam generated by a femtosecond laser emitter is divided into two light paths by a beam splitter. Interference fringes generated from one of the light paths are projected onto an object to be detected, and static interference fringes generated from the other light path are photographed by a CCD. The interference fringes are projected onto the object to be detected to obtain an interference fringe imaging sequence. After the laser beam is diffuse reflected, the diffuse reflected light passes through a digital micromirror device 113 loaded with a coding matrix, so that a plurality of images of the object to be detected are encoded to obtain an encoded image.

For S200, a system of a streak camera crops and compresses the encoded image to obtain a compressed interference fringe pattern. The laser beam passes through an optical system of a Mach-Zehnder interferometer to generate interference fringes, which are projected onto the object to be detected. The diffuse reflected light passes through two 4f systems and the digital micromirror device 113 for image encoding of the interference fringes and enters a streak camera in the compression ultrafast system to realize recording of two-dimensional spatial information of the interference fringes.

For S300, restoring a three-dimensional image from two-dimensional images is an ill-posed linear problem. An inverse model obtains a good restoration result according to a prior distribution of interference fringe patterns. Given a compressed interference fringe pattern of y obtained through measurement and a forward model (likelihood function Pyx), an interference fringe pattern sequence of an unknown signal x is estimated by a maximum posterior probability method.

The estimation is expressed as the following equation:

$$\begin{matrix}\hat{x} = {arg max}_{x} {p}_{x \vert y} ( x \vert y ) = {arg max}_{x} \frac{{p}_{y \vert x} ( y \vert x ) {p}_{x} ( x )}{{p}_{y} ( y )} \\ = {arg max}_{x} {p}_{y \vert x} ( y \vert x ) {p}_{x} ( x ) .\end{matrix}$$

Assuming that the measured signal contains additive white Gaussian noise (AWGN), the expression may be converted to:

$$\begin{matrix}\hat{x} = {arg max}_{x} {p}_{x \vert y} ( x \vert y ) = {arg max}_{x} exp [ - \frac{1}{2 {σ}_{ε}^{2}} {‖ y - Ax ‖}_{2}^{2} + log {p}_{x} ( x ) ] \\ = {arg min}_{x} \frac{1}{2} {‖ y - Ax ‖}_{2}^{2} - {σ}_{ε}^{2} log {p}_{x} ( x ) .\end{matrix}$$

By replacing an unknown noise variance & with a noise balance factor 2 and a negative log-prior function Pₓ(x) and constraining the optimization problem with a regularization term R(x), a to-be-solved equation is obtained as follows:

$$\hat{x} = {arg max}_{x} \frac{1}{2} {‖ y - Ax ‖}_{2}^{2} + λ R ( x ) ,$$

where x represents an interference fringe pattern sequence, \hat{x} represents an undecoded interference fringe pattern sequence, y represents a compressed interference fringe pattern of the streak camera, λ represents a noise balance factor, R(x) represents a regularization term, and A represents an operator.

The operator is expressed by the following equation: A=TSC, where T represents a spatiotemporal integration operator on an exposure time of an external CCD of the streak camera, S represents a temporal shearing operator in a vertical direction, and C represents an encoding operator of the mask.

In the compression ultrafast three-dimensional imaging system, according to the given operators and the sparsity of the dynamic scene, image reconstruction is implemented by solving the optimization problem in the above equation, and inverse solution processing is performed on the compressed interference fringe pattern using an inverse model to obtain an undecoded interference fringe pattern. The inverse model adopts a PnP framework and is based on Generalized Alternating Projection (GAP).

For S400, total variation image denoising is performed on the interference fringe pattern using a total variation image denoising algorithm.

The total variation image denoising algorithm is an image restoration algorithm for restoring a clean image from a noisy image, in which a noise model is established, an optimization algorithm solving module is used, and the restored image is made infinitely approximate an ideal denoised image through continuous iteration. Similar to deep learning, the noise model is analogous to a loss function. Through continuous training, the difference between the two is getting closer and closer, and a gradient descent method is also needed to quickly obtain an optimal solution.

The deep denoising is expressed by the following equation: v^{k+1}=D_{σ}(x^{k+1}), which may further be expressed as:

$${v}^{k + 1} = arg {min}_{v} \frac{{λ}_{1}}{γ} R ( v ) + {‖ {x}^{k + 1} - v ‖}_{2}^{2} ,$$

where x represents an interference fringe pattern sequence, v represents an auxiliary variable, k represents a number of iterations, λ₁ represents a regularization parameter, and γ represents a penalty factor.

v^{k+1}=D_{σ}(x^{k+1}) may be regarded as a denoiser, and δ represents a standard deviation of noise.

The denoiser should accommodate different input noise levels. A deep image denoising network may be used as a spatial image prior, i.e., a deep image denoising prior. A trained denoising model is used to reconstruct the interference fringe pattern sequence. The trained denoising model is to denoise images frame by frame.

Referring to FIG. 2, performing three-dimensional imaging on the denoised image to construct a three-dimensional model of the object to be detected in S500 includes, but not limited to, the following steps S510 to S530.

At S510, phase reconstruction is performed on the denoised image to obtain a phase map.

At S520, the phase map is unwrapped to obtain an absolute phase map.

At S530, three-dimensional coordinates of the object to be detected are calculated according to the absolute phase map and a preset calibration parameter, to construct the three-dimensional model of the object to be detected.

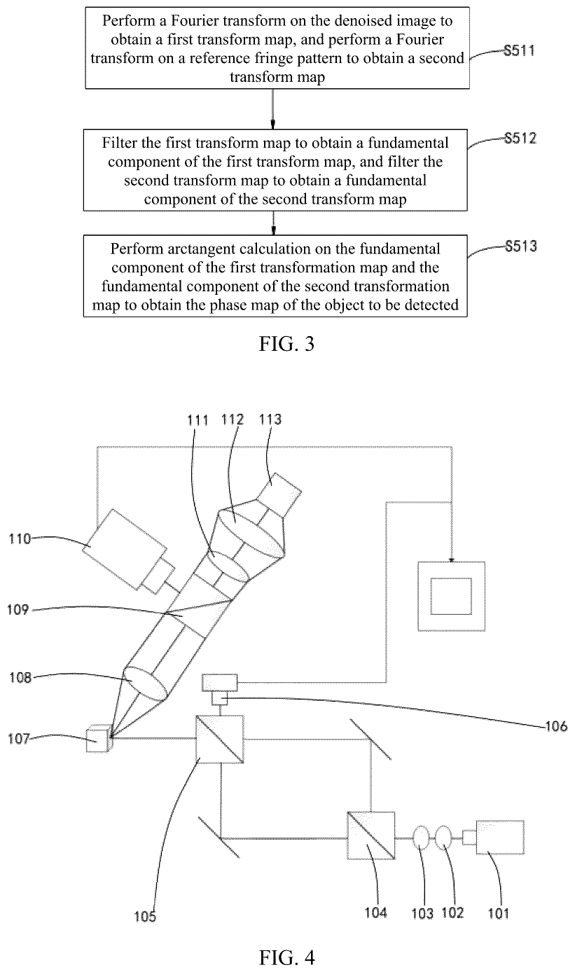

Referring to FIG. 3, performing phase reconstruction on the denoised image to obtain a phase map in S510 includes, but not limited to, the following steps S511 to S513.

At S511, a Fourier transform is performed on the denoised image to obtain a first transform map, and a Fourier transform is performed on a reference fringe pattern to obtain a second transform map.

At S512, the first transform map is filtered to obtain a fundamental component of the first transform map, and the second transform map is filtered to obtain a fundamental component of the second transform map.

At S513, arctangent calculation is performed on the fundamental component of the first transformation map and the fundamental component of the second transformation map to obtain the phase map of the object to be detected.

A fringe analysis is performed on the denoised and the reference fringe pattern using a Fourier transform. A Fourier transform is performed on the denoised image to obtain a first transform map, and a Fourier transform is performed on a reference fringe pattern to obtain a second transform map.

The intensity of the denoiser may be expressed as:

$$d ( x ) = {\sum }_{k = 0}^{+ ∞} {b}_{k} cos ( 2 π {kf}_{0} x + {Ψ}_{k} + {φ}_{k} ) .$$

The intensity of the reference fringe pattern may be expressed as:

$$r ( x ) = {\sum }_{k = 0}^{+ ∞} {b}_{k} cos ( 2 π {kf}_{0} x + {Ψ}_{k} ) ;$$

where f₀ represents a spatial frequency of a fundamental component of a fringe; bₖ represents an amplitude of a k^{th}-order harmonic component of a projected fringe, where for f₀, bₖ changes very slowly, and in practical measurements, bₖ is generally treated as a constant; ψₖ represents an initial phase of the k^{th}-order harmonic component; and σₖ represents a phase shift of the k^{th}-order harmonic component caused by fringe deformation.

Generally, harmonics with a spatial frequency of f₀ are referred to as the fundamental component of the fringe, and phase information of the fringe is directly extracted from the fundamental component, so the fundamental component constitutes the most important part of the fringe signal to be parsed.

A band-pass filter is used to filter the first transform map to obtain a fundamental component of the first transform map, and filter the second transform map to obtain a fundamental component of the second transform map.

The fundamental component of the first transform map is expressed as: d_{f}(x)=b₁ cos(2πf₀x+ψ₁+Δφ₁(x)). The fundamental component of the second transform map is expressed as: r_{f}(x)=b₁ cos(2πf₀x+ψ₁).

Arctangent calculation is performed on the fundamental component of the first transform map and the fundamental component of the second transform map that are obtained by Fourier transform processing and filtering processing of the denoised image and the reference fringe pattern, to obtain a fringe analysis result, i.e., the phase map.

The phase map is unwrapped to obtain accurate morphology data of the surface of the object, i.e., the absolute phase map.

A complex signal of the fundamental component of the second transform map is defined as R_{f}(x), a complex signal of the fundamental component of the first transform map is defined as D_{f}(x), and

$$Δ {φ}_{1} ( x ) = unwrap ( Im \{ In [ {D}_{f} ( x ) {R}_{f}^{*} ( x ) ] \} ) ,$$

where unwrap represents phase unwrapping, Im represents taking an imaginary part of a complex number, In represents a natural logarithm, and

$${R}_{f}^{*} ( x )$$

represents a complex conjugate of R_{f}(x).

Three-dimensional coordinates of the object to be detected are calculated according to the absolute phase map and a calibration parameter of a three-dimensional system, to obtain the three-dimensional model of the object to be detected.

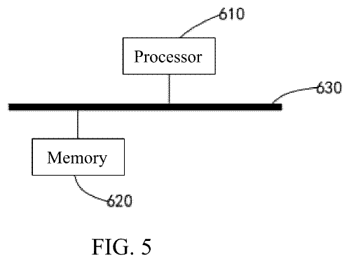

An embodiment of the present disclosure provides an electronic device. Referring to FIG. 5, the electronic device includes a memory 620, a processor 610, and a computer program stored in the memory 620 and executable by the processor 610. The computer program, when executed by the processor 610, causes the processor 610 to implement the compression ultrafast three-dimensional imaging method.

The electronic device may include any smart terminal such as a tablet computer or an in-vehicle computer.

Generally, in terms of the hardware structure of the electronic device, the processor 610 may be implemented by a general-purpose Central Processing Unit (CPU), a microprocessor, an Application Specific Integrated Circuit (ASIC), or one or more integrated circuits, and is configured for executing a related program to implement the technical schemes provided by the embodiments of the present disclosure.

The memory 620 may be implemented in the form of a Read Only Memory (ROM), a static storage device, a dynamic storage device, a Random Access Memory (RAM), etc. The memory 620 may store an operating system and other application programs. When the technical schemes provided by the embodiments of the present disclosure are implemented by software or firmware, related program code is stored in the memory 620, and is called by the processor 610 to execute the method according to the embodiments of the present disclosure.

The input/output interface is configured for enabling input and output of information.

The communication interface is configured for realizing communication interaction between the electronic device and other devices, either through wired communication (e.g., USB, network cable, etc.) or through wireless communication (e.g., mobile network, Wi-Fi, Bluetooth, etc.).

The bus 630 is configured for transmitting information between components of the electronic device (such as the processor 610, the memory 620, the input/output interface, and the communication interface). The processor 610, the memory 620, the input/output interface, and the communication interface are in communication connection with each other inside the electronic device through the bus 630.

An embodiment of the present disclosure provides a computer-readable storage medium, having computer-executable instructions stored therein. The computer-executable instructions, when executed by a processor, cause the processor to implement the compression ultrafast three-dimensional imaging method.

It should be appreciated that the operations of the method in the embodiments of the present disclosure may be implemented or practiced by computer hardware, by a combination of hardware and software, or by computer instructions stored in a non-transitory computer-readable memory. The method may be implemented using standard programming techniques. Each program may be implemented in a high-level procedural or object-oriented programming language to communicate with a computer system. However, the program may be implemented in assembly or machine language, if desired. In any case, the language may be a compiled or interpreted language. Moreover, the program can run on a dedicated integrated circuit programmed for that purpose.

In addition, operations of processes described herein may be executed in any suitable order unless otherwise indicated herein or otherwise clearly contradicted by context. The processes described herein (or variations and/or combinations thereof) may be executed under the control of one or more computer systems configured with executable instructions, and may be implemented as code (e.g., executable instructions, one or more computer programs, or one or more applications) collectively executed on one or more processors, by hardware, or combinations thereof. The computer program includes a plurality of instructions executable by one or more processors.

Further, the method may be operably connected to and implemented in any type of computing platform, including but not limited to, personal computers, smart phones, main-frames, workstations, networked or distributed computing environments, computer platforms separate, integral to, or in communication with charged particle tools or other imaging devices, and the like. Aspects of the present disclosure may be implemented in machine-readable code stored on a non-transitory storage medium or device, whether removable or integral to the computing platform, such as a hard disc, optical read and/or write storage mediums, RAM, ROM, and the like, so that it is readable by a programmable computer, for configuring and operating the computer when the storage medium or device is read by the computer to perform the processes described herein. Moreover, the machine-readable code, or portions thereof, may be transmitted over a wired or wireless network. The disclosure of this embodiment includes these and other various types of computer-readable storage media when such media contain instructions or programs for implementing the operations described above in conjunction with a microprocessor or other data processor. The present disclosure also includes the computer itself when programmed according to the methods and techniques described herein.

Computer programs can be applied to input data to perform the functions described herein and thereby transform the input data to generate output data to be stored in a non-volatile memory. The output information may also be applied to one or more output devices such as a display. In preferred embodiments of the present disclosure, the transformed data represents physical and tangible objects, including producing a particular visual depiction of the physical and tangible objects on a display.

Although the embodiments of the present disclosure have been shown and described, those having ordinary skills in the art should understand that various changes, modifications, replacements and variations may be made to the embodiments without departing from the principles and protection scope of the present disclosure, and the scope of the present disclosure is as defined by the appended claims and their equivalents.

Although some embodiments of the present disclosure have been described above, the present disclosure is not limited to the implementations described above. Those having ordinary skills in the art can make various equivalent modifications or replacements without departing from the protection scope of the present disclosure. Such equivalent modifications or replacements fall within the scope defined by the claims of the present disclosure.

1. A compression ultrafast three-dimensional imaging method, comprising:
encoding a plurality of interference fringe patterns of an object to be detected to obtain an encoded image;
compressing the encoded image to obtain a compressed interference fringe pattern of the object to be detected;
performing inverse solution processing on the compressed interference fringe pattern to obtain an undecoded interference fringe pattern;
performing total variation image denoising on the interference fringe pattern, and then performing deep denoising to obtain a denoised image; and
performing three-dimensional imaging on the denoised image to construct a three-dimensional model of the object to be detected.

2. The compression ultrafast three-dimensional imaging method of claim 1, wherein the inverse solution processing is performed on the compressed interference fringe pattern by solving a to-be-solved equation with an inverse model, to obtain the undecoded interference fringe pattern, wherein the to-be-solved equation is:
$$\hat{x} = arg {min}_{x} \frac{1}{2} {‖ y - Ax ‖}_{2}^{2} + λ R ( x ) ,$$
wherein x represents an interference fringe pattern sequence, \hat{x} represents an undecoded interference fringe pattern sequence, y represents a compressed interference fringe pattern, λ represents a noise balance factor, R(x) represents a regularization term, and A represents an operator.

3. The compression ultrafast three-dimensional imaging method of claim 2, wherein the operator is expressed by the following equation:
A=TSC, wherein T represents a spatiotemporal integration operator, S represents a temporal shearing operator, and C represents an encoding operator.

4. The compression ultrafast three-dimensional imaging method of claim 1, wherein the deep denoising is expressed by the following equation:
$${v}^{k + 1} = arg {min}_{v} \frac{{λ}_{1}}{γ} R ( v ) + {‖ {x}^{k + 1} - v ‖}_{2}^{2} ,$$
wherein x represents an interference fringe pattern sequence, v represents an auxiliary variable, k represents a number of iterations, λ₁ represents a regularization parameter, and γ represents a penalty factor.

5. The compression ultrafast three-dimensional imaging method of claim 1, wherein performing three-dimensional imaging on the denoised image to construct a three-dimensional model of the object to be detected comprises:
performing phase reconstruction on the denoised image to obtain a phase map;
unwrapping the phase map to obtain an absolute phase map; and
calculating three-dimensional coordinates of the object to be detected according to the absolute phase map and a preset calibration parameter, to construct the three-dimensional model of the object to be detected.

6. The compression ultrafast three-dimensional imaging method of claim 5, wherein performing phase reconstruction on the denoised image to obtain a phase map comprises:
performing a Fourier transform on the denoised image to obtain a first transform map, and performing a Fourier transform on a reference fringe pattern to obtain a second transform map;
filtering the first transform map to obtain a fundamental component of the first transform map, and filtering the second transform map to obtain a fundamental component of the second transform map; and
performing arctangent calculation on the fundamental component of the first transformation map and the fundamental component of the second transformation map to obtain the phase map of the object to be detected.

7. The compression ultrafast three-dimensional imaging method of claim 6, wherein the fundamental component of the first transform map is expressed as:
d_{f}(x)=b₁ cos(2πf₀x+ψ₁+Δφ₁(x)); and
the fundamental component of the second transform map is expressed as: r_{f}(x)=b₁ cos(2πf₀x+ψ₁), wherein f₀ represents a spatial frequency of a fundamental component of a fringe; b₁ represents an amplitude of a 1st-order harmonic component of a projected fringe; ψ₁ represents an initial phase of the 1st-order harmonic component; φ₁ represents a phase shift of the 1 st-order harmonic component caused by fringe deformation; and
$$Δ {φ}_{1} ( x ) = unwrap ( Im \{ In [ {D}_{f} ( x ) {R}_{f}^{*} ( x ) ] \} ) ,$$
wherein unwrap represents phase unwrapping, D_{f}(x) represents a complex signal of the fundamental component of the first transform map, R_{f}(x) represents a complex signal of the fundamental component of the second transform map, Im represents taking an imaginary part of a complex number, In represents a natural logarithm, and
$${R}_{f}^{*} ( x )$$
represents a complex conjugate of R_{f}(x).

8. A compression ultrafast three-dimensional imaging system, comprising a light source, a mask, an image capturing device, and an image processing device, wherein light generated by the light source first passes through the mask and then enters the image capturing device;
the mask plate is loaded with a coding matrix;
the mask is configured for encoding a plurality of interference fringe patterns of an object to be detected to obtain an encoded image;
the image capturing device is configured for compressing the encoded image to obtain a compressed interference fringe pattern of the object to be detected;
the image processing device is configured for performing inverse solution processing on the compressed interference fringe pattern to obtain an undecoded interference fringe pattern;
performing total variation image denoising on the interference fringe pattern, and then performing deep denoising to obtain a denoised image; and performing three-dimensional imaging on the denoised image to construct a three-dimensional model of the object to be detected.

9. An electronic device, comprising:
a memory, a processor, and a computer program stored in the memory and executable by the processor, wherein the computer program, when executed by the processor, causes the processor to perform the compression ultrafast three-dimensional imaging method of claim 1.

10. A non-transitory computer-readable storage medium, having computer-executable instructions stored therein, wherein the computer-executable instructions, when executed by a processor, cause the processor to perform the compression ultrafast three-dimensional imaging method of claim 1.
